(19) United States
(12) Patent Application Publication
(10) Pub. No.: US 2023/0407073 A1
(43) Pub. Date: Dec. 21, 2023

(54) RESIN COMPOSITION, ADHESIVE, MULTILAYER BODY, SURFACE PROTECTION FILM, METHOD FOR PRODUCING SURFACE PROTECTION FILM, AND METHOD FOR PROTECTING SURFACE

(71) Applicant: MITSUI CHEMICALS, INC., Tokyo (JP)

(72) Inventors: Takayuki UEKUSA, Ichihara-shi, Chiba (JP); Motoyasu YASUI, Chiba-shi, Chiba (JP); Yoshisada FUKAGAWA, Ichihara-shi, Chiba (JP)

(73) Assignee: MITSUI CHEMICALS, INC., Tokyo (JP)

(21) Appl. No.: 18/035,686

(22) PCT Filed: Oct. 29, 2021
(86) PCT No.: PCT/JP2021/040125

§ 371 Date: May 5, 2023

(30) Foreign Application Priority Data
Nov. 17, 2020 (JP) 2020-190965

(51) Int. Cl. C08L 23/20; C09J 123/20; C08F 210/14; B32B 27/08; B32B 27/32

(52) U.S. Cl. CPC C08L 23/20; C09J 123/20; C08F 210/14; B32B 27/08; B32B 27/32; C08L 2205/025; C08L 2205/03; C08L 2203/16; B32B 2307/748; B32B 2250/242; B32B 2250/03

(57) ABSTRACT

A resin composition containing a 4-methyl-1-pentene/α-olefin copolymer (A-1) satisfying (a) to (b), a 4-methyl-1-pentene/α-olefin copolymer (A-2) satisfying (c) to (d), and a thermoplastic resin (B) other than these, wherein a total content of (A-1) and (A-2) is 2 to 50% by mass, and a content of (B) is 50 to 98% by mass, based on 100% by mass of a total of (A-1), (A-2), and (B): (a) 65 to 80 mol % of a structural unit (i) derived from 4-methyl-1-pentene and 20 to 35 mol % of a structural unit (ii) derived from α-olefin; (b) a melting point observed by DSC is lower than 110° C. or not observed; (c) 80 to 90 mol % of the structural unit (i) and 10 to 20 mol % of the structural unit (ii) are contained; and (d) a melting point observed by DSC is 110 to 160° C.

### TECHNICAL FIELD

One embodiment of the present invention relates to a specific resin composition, an adhesive containing the resin composition, a multilayer body having an adhesive layer formed from the resin composition or the adhesive, a surface protection film containing the adhesive layer or the multilayer body, a method for producing the surface protection film, or a method for protecting a surface having surface irregularity height within a predetermined range.

### BACKGROUND ART

In order to protect an adherend such as a metal member made of, for example, aluminum, steel, or stainless steel, a member obtained by coating such a metal member with a coating material, a glass member, or a synthetic resin member, a surface protection film in which an adhesive layer and a base material layer are laminated is used. This surface protection film is peeled off from the adherend during the molding process of the adherend or at a predetermined time after the molding process.

The surface protection film is required to be capable of being easily adhered to an adherend, not to be easily peeled off, for example, during transportation of the adherend, and to be easily peelable from the adherend when the surface protection film is desired to be peeled off from the adherend during or after processing of the adherend. Therefore, the surface protection film is required to have various properties such as appropriate adhesiveness to an adherend, appropriate flexibility to the extent that the surface protection film itself does not damage the adherend surface, appropriate mechanical properties such as elongation properties in accordance with processing and molding of the adherend, and heat resistance.

When the surface protection film is used for protecting the surface of an adherend having irregularities on the surface thereof, such as a polarizing plate, a retardation plate, a light guide plate, a reflecting plate, or a prism plate, the contact area between the adherend and the adhesive layer is small, and therefore the adhesive layer is required to have an appropriate adhesion force even to such an adherend having irregularities on the surface thereof.

Further, depending on the application, the film is required to have good appearance, transparency and color tone and to be free from film defects such as gels and fisheyes. Furthermore, since the surface protection films are used and discarded in a large amount, they are required to be produced at low cost.

Conventionally, the adhesive layers are described as an adhesive layer composed of a propylene polymer (for example, Patent Literature 1), an adhesive layer containing a styrene polymer and an tackifier resin (for example, Patent Literatures 2 and 3), an adhesive layer containing a diene block copolymer (for example, Patent Literature 4), an adhesive layer containing a styrene elastomer and a propylene homopolymer (for example, Patent Literature 5), an adhesive layer containing a polymer block and a fatty acid amide compound (for example, Patent Literature 6), and an adhesive layer containing a 4-methyl-1-pentene/α-olefin copolymer and a thermoplastic resin (for example, Patent Literature 7).

### CITATION LIST

### Patent Literature

PATENT LITERATURE 1: WO2008/099865
PATENT LITERATURE 2: JP2007-126512A
PATENT LITERATURE 3: JP2012-255071A
PATENT LITERATURE 4: JP2008-274213A
PATENT LITERATURE 5: JP2011-126169A
PATENT LITERATURE 6: JP2013-121989A
PATENT LITERATURE 7: WO2015/012274A

### SUMMARY OF INVENTION

### Technical Problem

After the surface protection film is attached to the adherend, an increase in adhesion strength, that is, so-called adhesion increase, may occur due to, for example, the passage of time, or exposure to high temperature, but when the surface protection film is peeled off, the surface protection film is required to be able to be peeled off without, for example, adhesive residue, and thus the degree of such adhesion increase is also required to be small (low adhesion increase). It has been found that such adhesion increase increases to a greater extent, particularly in the case of an adherend having irregularities on the surface thereof.

Conventionally, however, an adhesive layer that is sufficiently adhered to the adherend and is easily peelable from the adherend when it is desired to be peeled off from the adherend has not been obtained, which has both appropriate adhesiveness to the adherend and low adhesion increase.

For example, the adhesive layers described in Patent Literatures 1 and 7 have room for improvement in terms of low adhesion increase. The adhesive layers described in Patent Literatures 2 and 3 are particularly insufficient in adhesion strength to an adherend having irregularities on the surface thereof, and are liable to cause stickiness or blocking, and are poor in extrusion moldability, resulting in poor productivity. The adhesive layers described in Patent Literatures 4 and 5 are particularly insufficient in adhesion strength to an adherend having irregularities on the surface thereof. In addition, the adhesive layer described in Patent Literature 6 may contaminate an adherend when the adhesive layer is peeled off from the adherend, and thus there is room for improvement in terms of peelability.

One embodiment of the present invention provides a resin composition capable of forming an adhesive layer having appropriate adhesiveness to an adherend and having low adhesion increase.

### Solution to Problem

As a result of diligent study to solve the above problems, the present inventors have found that a resin composition containing a plurality of 4-methyl-1-pentene copolymers having specific characteristics and a thermoplastic resin can form an adhesive layer that has appropriate adhesiveness to an adherend and is unlikely to increase in adhesion strength before and after heating and pressurization (for example, 80° C., 2 kgf). That is, the present inventors have found that the adhesive layer has appropriate adhesion strength and has good adhesive stability without a significant increase in adhesion strength even when the external environment changes, thereby completing the present invention.

Configuration examples of the present invention are as follows:
[1] A resin composition (X) comprising:
   a 4-methyl-1-pentene/α-olefin copolymer (A-1) satisfying following requirements (a) and (b);
   a 4-methyl-1-pentene/α-olefin copolymer (A-2) satisfying following requirements (c) and (d); and
   a thermoplastic resin (B) other than the copolymer (A-1) and the copolymer (A-2),
   wherein a total content of the copolymer (A-1) and the copolymer (A-2) is 2 to 50% by mass, and a content of the thermoplastic resin (B) is 50 to 98% by mass, based on 100% by mass of a total of the copolymer (A-1), the copolymer (A-2), and the thermoplastic resin (B):
   (a) when a total of a structural unit (i) derived from 4-methyl-1-pentene and a structural unit (ii) derived from an α-olefin having 2 to 20 carbon atoms (excluding 4-methyl-1-pentene) is 100 mol %, a content of the structural unit (i) is 65 to 80 mol %, and a content of the structural unit (ii) is 20 to 35 mol %;
   (b) a melting point observed by a differential scanning calorimeter (DSC) is lower than 110° C. or not observed;
   (c) when a total of the structural unit (i) derived from 4-methyl-1-pentene and the structural unit (ii) derived from an α-olefin having 2 to 20 carbon atoms (excluding 4-methyl-1-pentene) is 100 mol %, a content of the structural unit (i) is 80 to 90 mol %, and a content of the structural unit (ii) is 10 to 20 mol %; and
   (d) a melting point observed by a differential scanning calorimeter (DSC) is 110 to 160° C.
[2] The resin composition (X) according to [1], wherein as a tan δ peak obtained by performing dynamic viscoelastic measurement at a frequency of 10 rad/s (1.6 Hz) in a temperature range of −100 to 150° C., the resin composition (X) has a first peak with a peak temperature of lower than 0° C. and a second peak with a peak temperature of 0° C. or higher.
[3] The resin composition (X) according to [1] or [2], wherein a content of the copolymer (A-1) is 1 to 99% by mass, and a content of the copolymer (A-2) is 99 to 1% by mass, based on 100% by mass of the total content of the copolymer (A-1) and the copolymer (A-2).
[4] The resin composition (X) according to any one of [1] to [3], wherein at least one of the copolymer (A-1) and the copolymer (A-2) contains a structural unit derived from propylene.
[5] The resin composition (X) according to any one of [1] to [4], wherein the structural unit (ii) of at least one of the copolymer (A-1) and the copolymer (A-2) is a structural unit derived from propylene.
[6] The resin composition (X) according to any one of [1] to [5], wherein the thermoplastic resin (B) is an olefin elastomer (B1).
[7] The resin composition (X) according to any one of [1] to [5], wherein the thermoplastic resin (B) is a styrene elastomer (B2).
[8] An adhesive comprising the resin composition (X) according to any one of [1] to [7].
[9] A multilayer body comprising:
   an adhesive layer (L1) formed from the resin composition (X) according to any one of [1] to [7] or the adhesive according to [8]; and
   a base material layer (L2).
[10] The multilayer body according to [9], wherein the base material layer (L2) is a polypropylene layer.
[11] A surface protection film comprising:
   an adhesive layer formed from the resin composition (X) according to any one of [1] to [7] or the adhesive according to [8]; or
   the multilayer body according to [9] or [10].
[12] A method for producing a surface protection film, comprising a step of forming the surface protection film according to [11] by a T-die film forming method.
[13] A method of protecting a surface having surface irregularity height of 0.1 to 300 μm using the surface protection film according to [11] or the surface protection film produced by the production method according to [12].

### Advantageous Effects of Invention

According to one embodiment of the present invention, it is possible to easily form an adhesive layer having appropriate adhesiveness to an adherend and having low adhesion increase even after heating and pressurization, and a multilayer body and a surface protection film each comprising the adhesive layer.

Further, according to one embodiment of the present invention, even in the case of an adherend having irregularities on the surface thereof, the surface can be sufficiently protected.

### DESCRIPTION OF EMBODIMENTS

Hereinafter, embodiments of the present invention will be described in detail, but the present invention is not limited to the configurations of the following embodiments. In the present invention, “to” that defines a numerical range means the lower limit value or more and the upper limit value or less.

<<Resin Composition (X)>>

A resin composition (X) according to one embodiment of the present invention contains a 4-methyl-1-pentene/α-olefin copolymer (A-1) having specific physical properties, a 4-methyl-1-pentene/α-olefin copolymer (A-2) having specific physical properties, and a thermoplastic resin (B) other than the copolymer (A-1) and the copolymer (A-2) at a specific ratio.

The 4-methyl-1-pentene/α-olefin copolymer (A-1) and the 4-methyl-1-pentene/α-olefin copolymer (A-2) may be simply referred to as “copolymer (A-1)” and “copolymer (A-2)”, respectively, and the thermoplastic resin (B) other than the copolymer (A-1) and the copolymer (A-2) may be simply referred to as “thermoplastic resin (B)”.

The total content of the copolymer (A-1) and the copolymer (A-2) in the resin composition (X) is 2 to 50% by mass based on 100% by mass of the total of the copolymer (A-1), the copolymer (A-2), and the thermoplastic resin (B), and the upper limit value is preferably 45% by mass and more preferably 40% by mass, and the lower limit value is preferably 5% by mass, more preferably 6% by mass, and still more preferably 8% by mass.

The content of the thermoplastic resin (B) in the resin composition (X) is 50 to 98% by mass based on 100% by mass of the total of the copolymer (A-1), the copolymer (A-2), and the thermoplastic resin (B), and the lower limit value is preferably 55% by mass and more preferably 60% by mass, and the upper limit value is preferably 95% by mass, more preferably 94% by mass, and still more preferably 92% by mass.

When the total content of the copolymer (A-1) and the copolymer (A-2) and the content of the thermoplastic resin (B) are within the above ranges, it is possible to easily obtain an adhesive layer having appropriate adhesiveness to an adherend and having low adhesion increase.

The upper limit value of the content of the copolymer (A-1) based on 100% by mass of the total content of the copolymer (A-1) and the copolymer (A-2) is preferably 99% by mass, more preferably 90% by mass, still more preferably 85% by mass, and particularly preferably 80% by mass, and the lower limit value is preferably 1% by mass, more preferably 10% by mass, still more preferably 15% by mass, and particularly preferably 20% by mass.

The upper limit value of the content of the copolymer (A-2) based on 100% by mass of the total content of the copolymer (A-1) and the copolymer (A-2) is preferably 99% by mass, more preferably 90% by mass, still more preferably 85% by mass, and particularly preferably 80% by mass, and the lower limit value is preferably 1% by mass, more preferably 10% by mass, still more preferably 15% by mass, and particularly preferably 20% by mass.

When the content of the copolymer (A-1) and the content of the copolymer (A-2) are within the above ranges, it is possible to easily obtain an adhesive layer having appropriate adhesiveness to an adherend and having low adhesion increase.

The resin composition (X) does not contain either one of the copolymer (A-1) or the copolymer (A-2) but contains both of the copolymer (A-1) and the copolymer (A-2), it is possible to easily obtain an adhesive layer having a low adhesion increase, and in particular, it is possible to easily obtain an adhesive layer having appropriate adhesiveness to an adherend having irregularities on the surface thereof and having low adhesion increase even after heating and pressurization.

The resin composition (X) preferably satisfies the following requirements (x) and (y).

Requirement (x)

When a dynamic viscoelastic measurement of the resin composition (X) is performed at a frequency of 10 rad/s (1.6 Hz) and in a temperature range of −100 to 150° C. and the ratio of loss modulus to storage modulus at each temperature (loss tangent, tan δ) is plotted as a function of temperature, it is preferable that at least a first peak and a second peak are present.

Here, the first peak refers to a peak in the range of lower than 0° C., preferably −60° C. or higher, more preferably −50° C. or higher, still more preferably −45° C. or higher, and preferably lower than 0° C., more preferably −5° C. or lower, and still more preferably −10° C. or lower.

The first peak is a tan δ peak derived from the thermoplastic resin (B). There may be two or more first peaks. In other words, there may be two or more maximum values of tan δ in the range of lower than 0° C.

Also, the second peak refers to a peak in the range of 0° C. or higher, preferably 0° C. or higher, more preferably 5° C. or higher, still more preferably 10° C. or higher, and preferably 60° C. or lower, more preferably 50° C. or lower.

The second peak is derived from the copolymer (A-1) and/or the copolymer (A-2). There may be two or more second peaks. In other words, there may be two or more maximum values of tan δ in the range of 0° C. or higher. Further, when the tan δ peak derived from the copolymer (A-1) and the tan δ peak derived from the copolymer (A-2) overlap each other, the second peak may be observed as one broad peak.

Having the first and second peaks in the above temperature ranges can further increase the adhesion strength of the adhesive layer containing the resin composition (X).

Details such as measurement conditions are as described in the section of Examples described later.

Requirement (y)

When a dynamic viscoelastic measurement of the resin composition (X) is performed at a frequency of 10 rad/s (1.6 Hz) and in a temperature range of −100 to 150° C. and tan δ at each temperature is plotted as a function of temperature, the value of the peak of tan δ present at 0° C. or higher (the maximum value of the second peak) is preferably 0.1 or more, more preferably 0.15 or more, and preferably 2.0 or less, more preferably 1.5 or less.

When the peak value of tan δ at 0° C. or higher is within the above range, it is possible to easily obtain an adhesive layer having excellent adhesion strength at room temperature.

Details such as measurement conditions are as described in the section of Examples described later.

### 4-methyl-1-pentene/α-olefin copolymer (A-1)

The copolymer (A-1) satisfies the following requirements (a) and (b).

The copolymer (A-1) used in the resin composition (X) may be of one type or two or more types.

Requirement (a)

The copolymer (A-1) contains a structural unit (i) derived from 4-methyl-1-pentene and a structural unit (ii) derived from an α-olefin having 2 to 20 carbon atoms (excluding 4-methyl-1-pentene), and contains 65 to 80 mol % of the structural unit (i) and 20 to 35 mol % of the structural unit (ii) based on 100 mol % of a total of the structural unit (i) and the structural unit (ii).

The lower limit value of the content of the structural unit (i) based on 100 mol % of the total of the structural unit (i) and the structural unit (ii) is preferably 68 mol %, and the upper limit value is preferably 78 mol %, more preferably 75 mol %.

When the content of the structural unit (i) is the lower limit value or more, it is possible to easily obtain an adhesive layer having excellent irregularity followability, and when the content of the structural unit (i) is the upper limit value or less, it is possible to easily obtain an adhesive layer having appropriate flexibility.

The copolymer (A-1) contains a structural unit (i) derived from 4-methyl-1-pentene and a structural unit (ii) derived from an α-olefin having 2 to 20 carbon atoms (excluding 4-methyl-1-pentene), and when all the structural units constituting the copolymer (A-1) are 100 mol %, the lower limit value of the content of the structural unit (i) is preferably 60 mol %, more preferably 65 mol %, and still more preferably 68 mol %, and the upper limit value of the content of the structural unit (i) is preferably 80 mol %, more preferably 78 mol %, and still more preferably 75 mol %.

When the content of the structural unit (i) is the lower limit value or more, it is possible to easily obtain an adhesive layer having excellent irregularity followability, and when the content of the structural unit (i) is the upper limit value or less, it is possible to easily obtain an adhesive layer having appropriate flexibility.

The copolymer (A-1) contains a structural unit (i) derived from 4-methyl-1-pentene and a structural unit (ii) derived from an α-olefin having 2 to 20 carbon atoms (excluding 4-methyl-1-pentene), and when all the structural units constituting the copolymer (A-1) are 100 mol %, the lower limit value of the content of the structural unit (ii) is preferably 20 mol %, more preferably 22 mol %, and the upper limit value of the content of the structural unit (ii) is preferably 35 mol %, more preferably 32 mol %.

When the content of the structural unit (ii) is the upper limit value or less, it is possible to easily obtain an adhesive layer having excellent irregularity followability, and when the content of the structural unit (ii) is the lower limit value or more, it is possible to easily obtain an adhesive layer having appropriate flexibility.

The α-olefin from which the structural unit (ii) is derived may be either a linear α-olefin or a branched α-olefin.

Examples of the linear α-olefin include ethylene, propylene, 1-butene, 1-pentene, 1-hexene, 1-octene, 1-decene, 1-undecene, 1-dodecene, 1-tetradecene, 1-hexadecene, 1-octadecene, and 1-eicosene. The number of carbon atoms of the linear α-olefin is preferably 2 to 15, and more preferably 2 to 10.

Examples of the branched α-olefin include 3-methyl-1-butene, 3-methyl-1-pentene, 3-ethyl-1-pentene, 4,4-dimethyl-1-pentene, 4-methyl-1-hexene, 4,4-dimethyl-1-hexene, 4-ethyl-1-hexene, and 3-ethyl-1-hexene. The number of carbon atoms of the branched α-olefin is preferably 5 to 20, and more preferably 5 to 15.

Among these, ethylene, propylene, 1-butene, 1-pentene, 1-hexene, and 1-octene are preferable, ethylene and propylene are more preferable, and propylene is particularly preferable because a copolymer satisfying the following requirements (e) and (f) can be easily obtained.

The structural unit (ii) contained in the copolymer (A-1) may be of one type or two or more types.

An example of the copolymer (A-1) is a copolymer composed only of the structural unit (i) and the structural unit (ii). In this case, the total of structural unit (i) and structural unit (ii) is 100 mol %.

The copolymer (A-1) may further contain, in addition to the structural unit (i) and the structural unit (ii), a structural unit derived from a polymerizable monomer other than 4-methyl-1-pentene and an α-olefin having 2 to 20 carbon atoms, as long as the amount of the structural unit is small enough not to impair the object of the present invention, specifically 10 mol % or less, preferably 5 mol % or less, and more preferably 3 mol % or less.

The structural unit derived from another polymerizable monomer that may be contained in the copolymer (A-1) may be one type, or two or more types.

Preferred specific examples of such other polymerizable monomers include vinyl compounds having a cyclic structure such as styrene, vinylcyclopentane, vinylcyclohexane and vinylnorbornane; vinyl esters such as vinyl acetate; unsaturated organic acids or derivatives thereof such as maleic anhydride; conjugated dienes such as butadiene, isoprene, pentadiene and 2,3-dimethylbutadiene; and non-conjugated polyenes such as 1,4-hexadiene, 1,6-octadiene, 2-methyl-1,5-hexadiene, 6-methyl-1,5-heptadiene, 7-methyl-1,6-octadiene, dicyclopentadiene, cyclohexadiene, dicyclooctadiene, methylenenorbornene, 5-vinyl-2-norbornene, 5-ethylidene-2-norbornene, 5-methylene-2-norbornene, 5-isopropylidene-2-norbornene, 6-chloromethyl-5-isopropenyl-2-norbornene, 2,3-diisopropylidene-5-norbornene, 2-ethylidene-3-isopropylidene-5-norbornene and 2-propenyl-2,2-norbornadiene.

Here, in a case where the copolymer (A-1) contains a structural unit derived from another polymerizable monomer, the total content of the structural unit (ii) and the structural unit derived from another polymerizable monomer preferably satisfies the range of the content of the structural unit (ii). In this case, the total amount of the structural unit (i), the structural unit (ii), and the structural unit derived from another polymerizable monomer is 100 mol %.

The “structural unit derived from X” (where X is a compound having a carbon-carbon double bond) means a structural unit corresponding to X in a (co)polymer obtained using X as a monomer. For example, the “structural unit derived from 4-methyl-1-pentene” means a structural unit corresponding to 4-methyl-1-pentene in a 4-methyl-1-pentene (co)polymer obtained by using 4-methyl-1-pentene as a monomer.

Requirement (b)

In the copolymer (A-1), the melting point (Tm) observed by a differential scanning calorimeter (DSC) is lower than 110° C., or the melting point (Tm) is not observed by the differential scanning calorimeter (DSC), and preferably the melting point (Tm) is not observed.

When the copolymer (A-1) satisfies the requirement (b), the adhesion strength of the obtained adhesive layer can be adjusted.

Details such as measurement conditions are as described in the section of Examples described later.

A preferred embodiment of the copolymer (A-1) further satisfies one or more, more preferably two or more, still more preferably three or more, and particularly preferably all of the following requirements (e) to (i).

Requirement (e)

When a dynamic viscoelastic measurement of the copolymer (A-1) is performed at a frequency of 10 rad/s (1.6 Hz) and in a temperature range of −100 to 150° C. and tan δ at each temperature is plotted as a function of temperature, the peak temperature of tan δ derived from the glass transition temperature of the copolymer (A-1) is preferably 15° C. or higher, more preferably 20° C. or higher, and still more preferably 28° C. or higher. The peak temperature of tan δ derived from the glass transition temperature of the copolymer (A-1) is preferably 35° C. or lower and more preferably 33° C. or lower.

When the peak temperature of tan δ is within the above range, the obtained adhesive layer can be softened at room temperature, and an adhesive layer having excellent adhesion strength at room temperature can be easily obtained.

Details such as measurement conditions are as described in the section of Examples described later.

Requirement (f)

When a dynamic viscoelastic measurement of the copolymer (A-1) is performed at a frequency of 10 rad/s (1.6 Hz) and in a temperature range of −100 to 150° C. and tan δ at each temperature is plotted as a function of temperature, the peak value (maximum value) of tan δ is preferably 1.5 or more, more preferably 1.7 or more, and still more preferably 2.0 or more, and is preferably 5.0 or less, more preferably 4.0 or less, and still more preferably 3.0 or less.

When the peak value of tan δ is within the above range, it is possible to easily obtain an adhesive layer having excellent adhesion strength at room temperature.

Details such as measurement conditions are as described in the section of Examples described later.

Requirement (g)

The intrinsic viscosity [η] of the copolymer (A-1) measured in decalin at 135° C. is preferably 0.1 dl/g or more, more preferably 0.5 dl/g or more, and is preferably 5.0 dl/g or less, more preferably 4.0 dl/g or less, still more preferably 3.5 dl/g or less.

When the intrinsic viscosity [η] is within the above range, moldability is improved when forming the adhesive layer.

Details such as measurement conditions are as described in the section of Examples described later. The intrinsic viscosity [η] can be adjusted by controlling the molecular weight by using hydrogen during the polymerization.

Requirement (h)

The ratio of the weight-average molecular weight (MW) in terms of polystyrene measured by gel permeation chromatography (GPC) to the number-average molecular weight (Mn) in terms of polystyrene of the copolymer (A-1) (molecular weight distribution; Mw/Mn) is preferably 1.0 or more, more preferably 1.2 or more, and still more preferably 1.5 or more, and is preferably 3.5 or less, more preferably 3.0 or less, and still more preferably 2.8 or less.

When Mw/Mn exceeds the upper limit, the surface of the obtained adhesive layer is likely to be sticky due to the influence of the low-molecular-weight and low-stereoregularity polymer derived from the composition distribution, and the adherend is likely to be contaminated.

Details such as measurement conditions are as described in the section of Examples described later. When a catalyst described later is used, the copolymer (A-1) satisfying the requirement (h) can be easily obtained within the range of the intrinsic viscosity [η] shown in the requirement (g).

The weight-average molecular weight (Mw) of the copolymer (A-1) measured by gel permeation chromatography (GPC) is preferably 500 or more, more preferably 1,000 or more, and is preferably 10,000,000 or less, more preferably 5,000,000 or less, and still more preferably 2,500,000 or less in terms of polystyrene.

When Mw of the copolymer (A-1) is within the above range, the copolymer (A-1) is excellent in dispersibility in a resin composition or adhesive, which is preferable.

Details such as measurement conditions are as described in the section of Examples described later.

Requirement (i)

The copolymer (A-1) has a bulk density (as measured in accordance with ASTM D 1505) of preferably 830 kg/m³ or more, and is preferably 870 kg/m³ or less, more preferably 865 kg/m³ or less, still more preferably 855 kg/m³ or less.

By using the copolymer (A-1) having a density within the above range, a lightweight adhesive layer can be formed, which is preferable.

Details such as measurement conditions are as described in the section of Examples described later. The density can be appropriately adjusted by the comonomer composition ratio of the copolymer (A-1).

### 4-methyl-1-pentene/α-olefin copolymer (A-2)

The copolymer (A-2) satisfies the following requirements (c) and (d).

The copolymer (A-2) used in the resin composition (X) may be of one type or two or more types.

Requirement (c)

The copolymer (A-2) contains a structural unit (i) derived from 4-methyl-1-pentene and a structural unit (ii) derived from an α-olefin having 2 to 20 carbon atoms (excluding 4-methyl-1-pentene), and contains 80 to 90 mol % of the structural unit (i) and 10 to 20 mol % of the structural unit (ii) based on 100 mol % of a total of the structural unit (i) and the structural unit (ii).

The lower limit value of the content of the structural unit (i) based on 100 mol % of the total of the structural unit (i) and the structural unit (ii) is preferably 82 mol %, more preferably 84 mol %, and the upper limit value is preferably 88 mol %, more preferably 86 mol %.

When the content of the structural unit (i) is the lower limit value or more, it is possible to easily obtain an adhesive layer having excellent irregularity followability, and when the content of the structural unit (i) is the upper limit value or less, it is possible to easily obtain an adhesive layer having appropriate flexibility.

The copolymer (A-2) contains a structural unit (i) derived from 4-methyl-1-pentene and a structural unit (ii) derived from an α-olefin having 2 to 20 carbon atoms (excluding 4-methyl-1-pentene), and when all the structural units constituting the copolymer (A-2) are 100 mol %, the lower limit value of the content of the structural unit (i) is preferably 80 mol %, more preferably 82 mol %, and still more preferably 84 mol %, and the upper limit value of the content of the structural unit (i) is preferably 90 mol %, more preferably 88 mol %, and still more preferably 86 mol %.

When the content of the structural unit (i) is the lower limit value or more, it is possible to easily obtain an adhesive layer having excellent irregularity followability, and when the content of the structural unit (i) is the upper limit value or less, it is possible to easily obtain an adhesive layer having appropriate flexibility.

The copolymer (A-2) contains a structural unit (i) derived from 4-methyl-1-pentene and a structural unit (ii) derived from an α-olefin having 2 to 20 carbon atoms (excluding 4-methyl-1-pentene), and when all the structural units constituting the copolymer (A-2) are 100 mol %, the lower limit value of the content of the structural unit (ii) is preferably 10 mol %, more preferably 12 mol %, and still more preferably 14 mol %, and the upper limit value of the content of the structural unit (ii) is preferably 20 mol %, more preferably 18 mol %, and still more preferably 16 mol %.

When the content of the structural unit (ii) is the upper limit value or less, it is possible to easily obtain an adhesive layer having excellent irregularity followability, and when the content of the structural unit (ii) is the lower limit value or more, it is possible to easily obtain an adhesive layer having appropriate flexibility.

Examples of the α-olefin from which the structural unit (ii) is derived include the same olefins as the α-olefins exemplified in the section of the copolymer (A-1), and preferred olefins are also the same.

The structural unit (ii) contained in the copolymer (A-2) may be of one type or two or more types.

An example of the copolymer (A-2) is a copolymer composed only of the structural unit (i) and the structural unit (ii). In this case, the total of structural unit (i) and structural unit (ii) is 100 mol %.

The copolymer (A-2) may further contain, in addition to the structural unit (i) and the structural unit (ii), a structural unit derived from another polymerizable monomer other than 4-methyl-1-pentene and an α-olefin having 2 to 20 carbon atoms, as long as the amount of the structural unit is small enough not to impair the object of the present invention, specifically 10 mol % or less, preferably 5 mol % or less, and more preferably 3 mol % or less.

The structural unit derived from another polymerizable monomer that may be contained in the copolymer (A-2) may be one type, or two or more types.

Examples of the other polymerizable monomers include the same monomers as the other polymerizable monomers exemplified in the section of the copolymer (A-1).

Here, in a case where the copolymer (A-2) contains a structural unit derived from another polymerizable monomer, the total content of the structural unit (ii) and the structural unit derived from another polymerizable monomer preferably satisfies the range of the content of the structural unit (ii). In this case, the total amount of the structural unit (i), the structural unit (ii), and the structural unit derived from another polymerizable monomer is 100 mol %.

Requirement (d)

The melting point (Tm) of the copolymer (A-2) measured by a differential scanning calorimeter (DSC) is 110 to 160° C., preferably 120° C. or higher, more preferably 125° C. or higher, and is preferably 150° C. or lower, more preferably 140° C. or lower.

By using the copolymer (A-2) having a melting point (Tm) within the above range, it is possible to easily form an adhesive layer capable of suppressing the adhesion increase.

Details such as measurement conditions are as described in the section of Examples described later.

A preferred embodiment of the copolymer (A-2) satisfies one or more, more preferably two or more, still more preferably three or more, and particularly preferably all selected from the requirements (g) to (i) described for the copolymer (A-1) and the following requirements (j) to (k).

Requirement (j)

When a dynamic viscoelastic measurement of the copolymer (A-2) is performed at a frequency of 10 rad/s (1.6 Hz) and in a temperature range of −100 to 150° C. and tan δ at each temperature is plotted as a function of temperature, the peak temperature of tan δ derived from the glass transition temperature of the copolymer (A-2) is preferably 35° C. or higher, more preferably 38° C. or higher, and is preferably 60° C. or lower, more preferably 50° C. or lower, still more preferably 45° C. or lower.

When the copolymer (A-2) having a peak temperature of tan δ in the above range is used, the obtained resin composition (X) has a high value of tan δ (that is, high viscosity) while having appropriate hardness at room temperature, and consequently it becomes easy to adjust the adhesion strength of the adhesive layer.

Details such as measurement conditions are as described in the section of Examples described later.

Requirement (k)

When a dynamic viscoelastic measurement of the copolymer (A-2) is performed at a frequency of 10 rad/s (1.6 Hz) and in a temperature range of −100 to 150° C. and tan δ at each temperature is plotted as a function of temperature, the peak value (maximum value) of tan δ is preferably 0.5 or more, more preferably 0.7 or more, and still more preferably 0.9 or more, and is preferably 2.0 or less, more preferably 1.6 or less, and still more preferably 1.5 or less.

When the peak value of tan δ is within the above range, it becomes easy to adjust the adhesion strength of the adhesive layer.

Details such as measurement conditions are as described in the section of Examples described later.

[Method for Producing Copolymer (A-1) and Copolymer (A-2)]

A method for producing the copolymer (A-1) and the copolymer (A-2) is not particularly limited, and for example, they can be produced by polymerizing 4-methyl-1-pentene and an α-olefin in the presence of an appropriate polymerization catalyst.

Conventionally known catalysts, such as magnesium-supported titanium catalysts, metallocene catalysts described in, for example, WO2001/53369, WO2001/27124, JP3-193796, JP02-41303, WO2011/055803, and WO2014/050817, are suitably used as the polymerization catalysts.

[Thermoplastic Resin (B)]

The thermoplastic resin (B) is not particularly limited as long as it is a thermoplastic resin other than the copolymer (A-1) and the copolymer (A-2). By using the thermoplastic resin (B), the resin composition (X) can be imparted with properties such as good adhesiveness, moldability, and tackiness.

The thermoplastic resin (B) used in the resin composition (X) may be of one type or two or more types.

Examples of the thermoplastic resin (B) include an olefin elastomer (B1) other than the copolymer (A-1) and the copolymer (A-2); a styrene elastomer (B2); thermoplastic polyurethane; vinyl chloride resin; vinylidene chloride resin; acrylic resin; ethylene/vinyl acetate copolymer; ethylene/acrylate copolymer; ionomer; ethylene/vinyl alcohol copolymer; and polyvinyl alcohol.

Of these thermoplastic resins (B), at least one selected from the olefin elastomer (B1) and the styrene elastomer (B2) is preferably used. In addition, when the adherend has a surface with irregularities, the styrene elastomer (B2) is particularly preferable because an adhesive layer having high adhesion strength can be easily obtained. Here, in a case where the styrene elastomer (B2) is used as the thermoplastic resin (B), it is more preferable that the thermoplastic resin (B) is composed only of the styrene elastomer (B2).

[Olefin Elastomer (B1)]

Examples of the first aspect of the olefin elastomer (B1) include copolymers of ethylene and α-olefins having 3 to 20 carbon atoms; copolymers of ethylene, α-olefins having 3 to 20 carbon atoms, and cyclic olefins; ethylene copolymers containing various vinyl compounds such as styrene, vinyl acetates, (meth)acrylic acids, and (meth)acrylates as comonomers; copolymers of propylene and α-olefins having 4 to 20 carbon atoms; and copolymers of propylene, α-olefins having 4 to 20 carbon atoms, and cyclic olefins. Furthermore, examples of the first aspect of the olefin elastomer (B1) include copolymers of at least one selected from the group consisting of polyethylenes and polypropylenes and at least one selected from the group consisting of polybutadienes, hydrogenated polybutadienes, polyisoprenes, hydrogenated polyisoprenes, polyisobutylenes, and α-olefins. The form of the copolymerization may be either block copolymerization or graft copolymerization, but only in the case of a copolymer containing one selected from the group consisting of polyethylene and polypropylene and an α-olefin, the form of the copolymerization may be random copolymerization. The α-olefin is an olefin having a double bond at one end of the molecular chain, and 1-butene and 1-octene are preferably used, for example.

Examples of the first aspect of the olefin elastomer (B1) include block copolymers of polyolefin blocks forming a polymer having high crystallinity such as polypropylene as a hard portion and monomer copolymers showing non-crystallinity as a soft portion. Specific examples thereof include an olefin (crystalline)/ethylene/butylene/olefin block copolymer and a polypropylene/polyolefin (amorphous)/polypropylene block copolymer.

Examples of the commercially available product include DYNARON manufactured by JSR Corporation, TAFMER and NOTIO manufactured by Mitsui Chemicals, ENGAGE and VERSIFY manufactured by Dow Chemical Company, and Vistamaxx manufactured by ExxonMobil Chemical Company.

Examples of the second aspect of the olefin elastomer (B1) include a blend of at least one selected from the group consisting of polyethylenes and polypropylenes and at least one selected from the group consisting of ethylene/propylene copolymers, ethylene/propylene/diene copolymers, ethylene/butene copolymers, and hydrogenated styrene/butadiene.

The ethylene/propylene copolymer, ethylene/propylene/diene copolymer, and ethylene/butene copolymer may be partially or completely crosslinked.

Specific examples of the second aspect of the olefin elastomer (B1) include commercially available products such as TAFMER and MILASTOMER manufactured by Mitsui Chemicals, ESPOLEX manufactured by Sumitomo Chemical Co., Ltd., THERMORUN and ZELAS manufactured by Mitsubishi Chemical Corporation, and Santoplene manufactured by ExxonMobil Chemical Company.

The olefin elastomer (B1) may be modified with at least one functional group selected from the group consisting of acid anhydride groups, carboxyl groups, amino groups, imino groups, alkoxysilyl groups, silanol groups, silyl ether groups, hydroxyl groups, and epoxy groups.

When the olefin elastomer (B1) is used in the resin composition (X), the olefin elastomer (B1) to be used may be of one type or two or more types.

[Styrene elastomer (B2)]

The styrene elastomer (B2) is not particularly limited, and examples thereof include block copolymers of a polystyrene block as a hard portion (crystalline portion) and a diene monomer block as a soft portion (SBS), hydrogenated styrene/butadiene/styrene random copolymers (HSBR), styrene/ethylene/propylene/styrene block copolymers (SEPS), styrene/ethylene/butene/styrene block copolymers (SEBS), styrene/isoprene/styrene block copolymers (SIS), styrene/isobutylene/styrene copolymers (SIBS), styrene/isobutylene copolymers (SIB), and styrene/ethylene/butene/styrene/styrene block copolymers (SEBSS).

SEBS, SIB, and SIBS, which are excellent in initial adhesion force and flexibility, are preferable among the above styrene elastomers.

Specific examples of HSBR include commercially available products such as DYNARON manufactured by JSR Corporation.

Examples of SEPS include those obtained by hydrogenating a styrene/isoprene/styrene block copolymer (SIS). Specific examples of SIS include commercially available products such as JSR SIS manufactured by JSR Corporation, HYBLER manufactured by Kuraray Co., Ltd., and KRATON D manufactured by Kraton Corporation.

Specific examples of SEPS include commercially available products such as SEPTON manufactured by Kuraray Co., Ltd. and KRATON manufactured by Kraton Corporation.

Specific examples of SEBS include commercially available products such as TUFTEC manufactured by Asahi Kasei Corporation and KRATON manufactured by Kraton Corporation.

Specific examples of SIB and SIBS include commercially available products such as SIBSTAR manufactured by Kaneka Corporation.

Examples of SEBSS include products in which styrene is polymerized together with butadiene and isoprene in the soft portion to introduce a styrene moiety into the soft portion, thereby adjusting the adhesion force, and specific examples thereof include commercially available products such as S.O.E. manufactured by Asahi Kasei Corporation.

When the styrene elastomer (B2) is used in the resin composition (X), the styrene elastomer (B2) to be used may be of one type or two or more types.

When the resin composition (X) is used for an adherend surface with large surface irregularities, it is preferable to use the styrene elastomer (B2) as the thermoplastic resin (B). In this case, the surface irregularity height of the adherend surface is preferably 0.1 μm or more, more preferably 1 μm or more, and preferably 300 μm or less, more preferably 100 μm or less, still more preferably 50 μm or less, particularly preferably 30 μm or less.

The surface irregularity height in the present invention is a value measured by observing the surface of the adherend with a scanning probe microscope (SPM).

[Other Components]

The resin composition (X) may be a composition composed only of the copolymer (A-1), the copolymer (A-2) and the thermoplastic resin (B), or may further contain other conventionally known components in addition to the copolymer (A-1), the copolymer (A-2) and the thermoplastic resin (B), as required.

Each of these other components may be used alone or in combination of two or more.

Examples of the other components include tackifiers, weather-resistant stabilizers, heat-resistant stabilizers, antistatic agents, slip inhibitors, anti-blocking agents, anti-fogging agents, lubricants, pigments, dyes, plasticizers, anti-aging agents, hydrochloric acid absorbers, antioxidants, crystal nucleating agents, antifungal agents, antibacterial agents, flame retardants, fillers (inorganic fillers, organic fillers), and softeners.

[Tackifier]

Specific examples of the tackifiers include a substance in a resin form manufactured and sold as tackifiers: coumarone resins such as coumarone/indene resins; phenolic resins such as phenol/formaldehyde resins and xylene/formaldehyde resins; terpene resins such as terpene/phenol resins, terpene resins (α,β-pinene resins), aromatic-modified terpene resins, and hydrogenated terpene resins; petroleum hydrocarbon resins such as synthetic polyterpene resins, aromatic hydrocarbon resins, aliphatic hydrocarbon resins, aliphatic cyclic hydrocarbon resins, hydrogenated hydrocarbon resins, and hydrocarbon tackifying resins; and rosin derivatives such as pentaerythritol esters of rosin, glycerin esters of rosin, hydrogenated rosin, hydrogenated rosin esters, special rosin esters, and rosin tackifiers.

Among these components, preferred are hydrogenated resins such as hydrogenated hydrocarbon resins, hydrogenated aliphatic cyclic hydrocarbon resins, hydrogenated aliphatic/alicyclic petroleum resins, hydrogenated terpene resins, and hydrogenated synthetic polyterpene resins; and rosin derivatives such as pentaerythritol esters of rosin, glycerin esters of rosin, hydrogenated rosin, hydrogenated rosin esters, special rosin esters, and rosin tackifiers, having a softening point of preferably 70° C. or higher, more preferably in the range of 70 to 130° C.

By using a tackifier, the adhesion strength of the obtained adhesive layer to the adherend can be easily adjusted.

When the resin composition (X) contains the tackifier, the content of the tackifier is preferably 5 to 100 parts by mass based on 100 parts by mass of the total of the copolymer (A-1), the copolymer (A-2), and the thermoplastic resin (B).

[Softener]

As the softener, any conventionally known softeners can be used, and specific examples thereof include petroleum substances such as process oil, lubricating oil, paraffin, liquid paraffin, polyethylene wax, polypropylene wax, petroleum asphalt and petrolatum; coal tars such as coal tar and coal tar pitch; fatty oils such as castor oil, linseed oil, rapeseed oil, soybean oil, coconut oil and tall oil; waxes such as beeswax, carnauba wax and lanolin; fatty acids such as ricinoleic acid, palmitic acid, stearic acid, 12-hydroxystearic acid, montanic acid, oleic acid and erucic acid or metal salts thereof; ester plasticizers such as dioctyl phthalate, dioctyl adipate and dioctyl sebacate; microcrystalline wax, liquid polybutadiene or modified or hydrogenated products thereof; and liquid thiokol.

[Filler]

Examples of the filler include powder fillers such as mica, carbon black, silica, calcium carbonate, talc, graphite, stainless steel, and aluminum; and fibrous fillers such as glass fiber and metal fiber. Examples thereof further include hydrophilic layered clay minerals and hydrophilic inorganic compounds in specific shapes (excluding layered).

Examples of the hydrophilic layered clay minerals include phyllosilicate minerals in which a plurality of layers extending two-dimensionally are laminated, such as smectite. Smectites are minerals of the montmorillonite group and examples thereof include montmorillonite, magnesium montmorillonite, iron montmorillonite, iron magnesium montmorillonite, beidellite, aluminium beidellite, nontronite, aluminium nontronite, saponite, aluminium saponite, hectorite, sauconite, stevensite, and bentonites.

Examples of the hydrophilic layered clay minerals further include vermiculite, halloysite, swelling mica, and graphite.

As the hydrophilic layered clay minerals, commercially available products can be used, and specific examples thereof include natural products such as KUNIPIA series (montmorillonites, manufactured by Kunimine Industries Co., Ltd.), BENGEL series (bentonites, manufactured by Hojun Co., Ltd.), and SOMASIF ME series (swelling micas, manufactured by Katakura & Co-op Agri Corporation.), and synthetic products such as SUMECTON (saponites, manufactured by Kunimine Industries Co., Ltd.), LUCENTITE SWN series (hectorite, manufactured by Katakura & Co-op Agri Corporation.), and LAPONITE (hectorite, manufactured by Rockwood Holdings Inc.). In general, synthetic products have a shorter maximum length than natural products, and thus synthetic products are preferable from the viewpoint of obtaining small oil droplets.

[Flame Retardant]

Examples of the flame retardant include inorganic compounds such as antimony flame retardants, aluminum hydroxide, magnesium hydroxide, zinc borate, guanidine flame retardants and zirconium flame retardants; phosphoric esters and other phosphorus compounds such as ammonium polyphosphate, ethylenebistris(2-cyanoethyl)phosphonium chloride, tris(tribromophenyl)phosphate and tris(3-hydroxypropyl)phosphine oxide; chlorine flame retardants such as chlorinated paraffin, chlorinated polyolefin and perchlorocyclopentadecane; and bromine flame retardants such as hexabromobenzene, ethylenebisdibromonorbornanedicarboximide, ethylenebistetrabromophthalimide, tetrabromobisphenol A derivatives, tetrabromobisphenol S and tetrabromodipentaerythritol.

The total amount of the components other than the tackifier such as the softener, the filler, and the flame retardant is preferably 0.001 to 50 parts by mass based on 100 parts by mass of the total of the copolymer (A-1), the copolymer (A-2), and the thermoplastic resin (B).

[Method for Preparing Resin Composition (X)]

The resin composition (X) can be prepared by blending the copolymer (A-1), the copolymer (A-2), the thermoplastic resin (B), and, if necessary, the other components in the amounts as described above and mixing them by various known methods. Examples of the known method include a method of mixing the components using, for example, a plastomill, a Henschel mixer, a V-blender, a ribbon blender, a tumbler blender, or a kneader-ruder, and a method of mixing the component before melt-kneading the mixture using, for example, a single-screw extruder, a twin-screw extruder, a kneader, or a Banbury mixer, and then granulating or pulverizing the kneaded product.

<<Adhesive>>

An adhesive according to one embodiment of the present invention (hereinafter also referred to as “the present adhesive”) is not particularly limited as long as it contains the resin composition (X), but is usually composed (only) of the resin composition (X).

Since the present adhesive contains the resin composition (X), it is possible to easily form an adhesive layer having appropriate adhesiveness to the extent that it does not spontaneously fall from the adherend and having low adhesion increase. Further, when the present adhesive is used for an adherend having irregularities on the surface thereof, the present adhesive follows the shape of the irregularities of the adherend to increase the adhesive area, and even for the adherend having irregularities on the surface thereof, an adhesive layer can be easily formed which has sufficient adhesion strength at the time of initial adhesion and can suppress adhesion increase because the contact area with the adherend does not greatly increase before and after heating and pressurization.

The present adhesive can be used as a material for forming the adhesive layer (L1) of the multilayer body described below.

<<Multilayer Body>>

A multilayer body according to one embodiment of the present invention (hereinafter also referred to as “the present multilayer body”) has an adhesive layer (L1) formed from the resin composition (X) or the present adhesive, and a base material layer (L2).

Since the present multilayer body has the adhesive layer (L1), it is a multilayer body containing an adhesive layer having appropriate adhesiveness to an adherend and having low adhesion increase. Further, when the present multilayer body is attached to an adherend having irregularities on the surface thereof, the adhesive layer (L1) follows the shape of the irregularities of the adherend to increase the adhesive area, and even for the adherend having irregularities on the surface thereof, the adhesive layer has sufficient adhesion strength at the time of initial adhesion and the contact area with the adherend is not greatly increased before and after heating and pressurization, and thus the adhesion increase can be suppressed and the adhesion strength can be stably maintained.

The thickness of the present multilayer body may be appropriately selected according to the application of the present multilayer body, and is not particularly limited, but is preferably 10 μm or more, more preferably 16 μm or more, and is preferably 1000 μm or less, more preferably 500 μm or less.

The adhesion strength (adhesion strength at 23° C.) of the present multilayer body (adhesive layer (L1)) to an acrylic plate after the present multilayer body is left at 23° C. for one day is preferably 0.5 N/50 mm or more, more preferably 0.6 N/50 mm or more, and is preferably 25 N/50 mm or less, more preferably 20 N/50 mm or less.

The adhesion strength (adhesion strength after heating at 60° C.) of the present multilayer body (adhesive layer (L1)) to an acrylic plate after the present multilayer body is left at 60° C. for one day is preferably 0.5 N/50 mm or more, more preferably 0.8 N/50 mm or more, and is preferably 35 N/50 mm or less, more preferably 30 N/50 mm or less.

The adhesion strength (adhesion strength after heating at 80° C.) of the present multilayer body (adhesive layer (L1)) to an acrylic plate after the present multilayer body is left at 80° C. for one day is preferably 0.5 N/50 mm or more, more preferably 0.8 N/50 mm or more, and is preferably 35 N/50 mm or less, more preferably 30 N/50 mm or less.

Specifically, the adhesion strength is measured by the method described in Examples below.

The upper limit of the adhesion increasing rate of the adhesion strength after heating at 60° C. to the adhesion strength at 23° C. of the present multilayer body (adhesive layer (L1)) is preferably 100% or less, more preferably 96% or less, still more preferably 80% or less, and particularly preferably 58% or less. The lower limit is not limited because it is preferable that the adhesion increasing rate of the adhesion strength after heating at 60° C. to the adhesion strength at 23° C. of the present multilayer body (adhesive layer (L1)) be low, but it is usually 5% or more.

The upper limit of the adhesion increasing rate of the adhesion strength after heating at 80° C. to the adhesion strength at 23° C. of the present multilayer body (adhesive layer (L1)) is preferably 100% or less, more preferably 70% or less, and still more preferably 58% or less. The lower limit is not limited because it is preferable that the adhesion increasing rate of the adhesion strength after heating at 80° C. to the adhesion strength at 23° C. of the present multilayer body (adhesive layer (L1)) be low, but it is usually 5% or more.

Specifically, the adhesion increasing rate is measured by the method described in Examples below.

<Adhesive Layer (L1)>

The adhesive layer (L1) is not particularly limited as long as it contains the resin composition (X), but is usually formed (only) from the resin composition (X) or the present adhesive.

The present multilayer body is usually used by being attached to an adherend so that the adhesive layer (L1) is in contact with the adherend.

The components of the adhesive layer (L1) are preferably adjusted according to the physical properties of the attachment face of the adherend, for example, the degree of irregularity of the surface (surface roughness), and for example, when the surface roughness of the attachment face of the adherend is high, a strong adhesive type material is preferably used. The adjustment may be performed within the range described in the section of the resin composition (X).

The thickness of the adhesive layer (L1) is not particularly limited, and may be appropriately selected according to the type of adherend and required physical properties (for example, adhesion strength), but is usually 1 μm or more, preferably 3 μm or more, and is usually 500 μm or less, preferably 300 μm or less.

<Base Material Layer (L2)>

The base material layer (L2) is not particularly limited, and conventionally known substrate layers can be used.

The material constituting the base material layer (L2) is preferably a thermoplastic resin such as polyolefin resins, and specific examples thereof include polypropylene resins (for example, propylene homopolymers and random or block copolymers of propylene and a small amount of an α-olefin), polyethylene resins (for example, low-density polyethylene, medium-density polyethylene, high-density polyethylene and linear low-density polyethylene), known ethylene polymers (for example, ethylene/α-olefin copolymers, ethylene/ethyl acrylate copolymers, ethylene/vinyl acetate copolymers, ethylene/methyl methacrylate copolymers and ethylene/n-butyl acrylate copolymers), known propylene copolymers (for example, propylene/α-olefin copolymers) and poly(4-methyl-1-pentene). Among these, polyethylene, polypropylene, and poly(4-methyl-1-pentene) are more preferable, and propylene is particularly preferable from the viewpoint of, for example, interlayer adhesion with the adhesive layer, transparency, heat resistance.

The material constituting the base material layer may be of one type or two or more types.

When polypropylene is used as the material constituting the base material layer (L2), the obtained base material layer (L2) is a propylene layer, and the propylene layer is preferably a layer composed of propylene.

The base material layer (L2) may be uniaxially or biaxially stretched.

The surface of the base material layer (L2) may be treated by a surface-treatment method such as corona-discharge treatment, plasma treatment, flame treatment, electron-beam irradiation treatment and UV irradiation treatment, and the base material layer (L2) may be a colorless transparent layer, or may be a colored or printed layer.

In addition, the base material layer (L2) may contain an additive such as a release agent in order to impart a function such as lubricity to the surface as necessary.

The thickness of the base material layer (L2) may be appropriately selected according to the application of the present multilayer body, and is not particularly limited, but is preferably 9 μm or more, more preferably 15 μm or more, and is preferably 500 μm or less, more preferably 100 μm or less.

<Structure of the Present Multilayer Body>

The present multilayer body is not particularly limited as long as it has an adhesive layer (L1) and a base material layer (L2). Suitable applications of the present multilayer body include surface protection films.

The adhesive layer (L1) contained in the present multilayer body may be one layer or two layers or more, and the base material layer (L2) contained in the present multilayer body may also be one layer or two layers or more. For example, when the present multilayer body includes two or more adhesive layers (L1), these layers may be the same layer or different layers. The same applies to the case where two or more other layers (including the base material layer (L2)) are included.

One suitable example of the present multilayer body is a multilayer body in which the adhesive layer (L1) is laminated on one side or both sides of a single-layer or multi-layer base material layer (L2), and specific examples thereof include a two-layer film in which the base material layer (L2) and the adhesive layer (L1) are laminated in this order, and a three-layer film in which the adhesive layer (L1), the base material layer (L2), and the adhesive layer (L1) are laminated in this order.

In addition, the present multilayer body may contain a layer other than the adhesive layer (L1) and the base material layer (L2).

Examples of the other layers include a front surface layer (L3) provided on a side of the base material layer (L2) opposite to the adhesive layer (L1), for example, in order to facilitate feeding of the multilayer body when the multilayer body is formed into a roll, and an intermediate layer (L4) provided between the adhesive layer (L1) and the base material layer (L2).

The surface layer (L3) and intermediate layer (L4) are not particularly limited, and conventionally known layers can be used.

The other layers contained in the present multilayer body may be one layer or two or more layers.

<Method for Producing the Present Multilayer Body>

The method for producing the present multilayer body is not particularly limited, and a known method for forming a multilayer film may be used, and preferred examples of the method include a method of co-extruding the adhesive layer (L1) and the base material layer (L2) using a T-die film forming method or an inflation film forming method, and a method of extrusion-coating the adhesive layer (L1) on the base material layer (L2) formed in advance. In another method, a solution-form resin composition (X) is applied onto the base material layer (L2) to form the adhesive layer (L1) on the base material layer (L2). Among these, a method of co-extruding the adhesive layer (L1) and the base material layer (L2) is preferable, and a T-die film forming method is more preferable as the co-extruding method.

There are no particular restrictions on the method of producing a multilayer body including the base material layer (L2), the adhesive layer (L1), and the front surface layer (L3) to be provided as needed, including a method of forming the front surface layer (L3) in advance by T-die film forming or inflation film forming and laminating the base material layer (L2) and the adhesive layer (L1) on the front surface layer (L3) by known lamination methods such as extrusion lamination and extrusion coating, or a method of making the front surface layer (L3), the base material layer (L2), and the adhesive layer (L1) independently into a film and then laminating each film by dry lamination, although co-extrusion, in which the raw material forming each layer of the front surface layer (L3), the base material layer (L2), and the adhesive layer (L1) is subjected to a multilayer extruder to form, is preferred from the viewpoint of productivity, and T-die film forming method is more preferred as a method for co-extrusion. This applies similarly to the production of multilayer body having other layers such as the intermediate layer (L4).

The present multilayer body may be stretched uniaxially or biaxially.

As a preferred method of uniaxial stretching, a commonly used roll stretching method can be exemplified. Examples of the biaxial stretching method include a sequential stretching method in which biaxial stretching is performed after uniaxial stretching, and a simultaneous biaxial stretching method such as a tubular stretching method.

<Applications of the Present Multilayer Body>

Examples of applications of the present multilayer body include adhesive sheets and surface protection films.

Specifically, it can be suitably used as a surface protection film to protect metal members made of, for example, aluminum, steel, or stainless steel, members obtained by coating such metal members with a coating material, glass members, synthetic resin members, and adherends such as home appliances, automobile parts, and electronic parts using these members.

In addition, films or tapes used in the electronics field, such as, for example, adhesive films, protection films, semiconductor process protection films, lens protection films, semiconductor wafer backgrind tapes, dicing tapes, and substrate protection tapes (example: protection tape for plating mask used in plating flexible printed circuit boards); window glass protection film; baking coating film; can also be used suitably.

In addition, since the adhesive layer (L1) has irregularity followability, it is also suitably used for a prism sheet or a reflection sheet with many irregular structures on the surface, a sheet for protecting a surface that is wrinkled, for example.

<<Surface Protection Film>>

A surface protection film according to one embodiment of the present invention includes an adhesive layer formed from the resin composition (X) or the present adhesive, or the present multilayer body. The surface protection film is used by being attached to an adherend to be protected.

The surface protection film may be composed only of the adhesive layer, may be composed only of the present multilayer body, or may include the adhesive layer or the present multilayer body and another layer. For example, in order to prevent blocking (sticking) between the surface protection films, a release paper or a release film may be sandwiched between the surface protection films, or a release agent may be applied to the exposed surface of the base material layer (L2).

Although the method of producing the surface protection film is not particularly limited, it is preferable to include a step of forming the film by the T-die film forming method, specifically, it is preferable to produce the surface protection film by (co)extruding the resin composition (X) or the present adhesive together with the base material layer (L2) and other layer forming materials from the T-die, if necessary.

The thickness of the surface protection film is not particularly limited and may be appropriately selected according to the application of the surface protection film, but is preferably 5 μm or more, more preferably 10 μm or more, and is preferably 1000 μm or less, more preferably 500 μm or less.

<<Method for Protecting Surface>>

A method for protecting a surface according to one embodiment of the present invention is a method for protecting a surface of an adherend using the surface protection film, and specifically, the adherend surface is protected by attaching the surface protection film to the adherend.

The adherend surface is a surface having surface irregularity height of preferably 0.1 μm or more, more preferably 1 μm or more, and preferably 300 μm or less, more preferably 100 μm or less, still more preferably 50 μm or less, particularly preferably 30 μm or less, from the viewpoint of further exhibiting the effect of the present invention. An example of an adherend having such a surface is a prism sheet.

Since the surface protection film has appropriate adhesiveness even to an adherend having such surface irregularity height, the surface protection film can sufficiently protect the adherend.

### EXAMPLES

An embodiment of the present invention will be described below with reference to Examples, but the present invention is not limited to these Examples.

[Measurement Conditions]

Measurement conditions for the following physical properties are as follows.

[Composition]

The contents of the structural unit (i) and the structural unit (ii) in the polymer were measured by ¹³C-NMR using the following apparatus and conditions.

Using ECP 500 type nuclear magnetic resonance equipment made by JEOL Ltd., the following measurements were made: solvent was a mixture of o-dichlorobenzene and heavy benzene (80/20 volume %), sample concentration was 55 mg/0.6 mL, measurement temperature was 120° C., observation nucleus was ¹³C (125 MHz), sequence was single-pulse proton decoupling, pulse width was 4.7 μs (45° pulse), repetition time was 5.5 seconds, number of integrations was 10,000 or more, and 27.50 ppm was measured as a reference value of chemical shift.

[Intrinsic Viscosity]

The intrinsic viscosity [η] (dl/g) of the copolymer obtained in the following Synthesis Example was measured at 135° C. using a decalin solvent.

Specifically, about 20 mg of the copolymer was dissolved in 15 ml of decalin, and the specific viscosity ηₛₚ was measured in an oil bath at 135° C. To the decalin solution, 5 ml of the decalin solvent was added to dilute the solution, and then the specific viscosity ηₛₚ was measured in the same manner. This dilution operation was repeated two more times, and as shown in Equation (1) below, a value of ηₛₚ/C when the concentration (C) was extrapolated to 0 was taken as the intrinsic viscosity [η] (unit: dl/g).

[η]=lim(ηₛₚ/C)(C→0) (1)

[Molecular Weight and Molecular Weight Distribution]

The molecular weights of the copolymers obtained in Synthetic Examples below were measured at a flow rate of 1.0 ml/min at 140° C. using a liquid chromatograph: ALC/GPC 150-C plus type (integrated differential refractor detector) made by Waters, two GMH6-HTs and two GMH6-HTLs made by Tosoh Corporation connected in series as columns, and o-dichlorobenzene as a mobile phase medium. The measurement time per sample was 60 minutes.

The obtained chromatogram was analyzed by a known method using a calibration curve using a standard polystyrene sample to determine the weight-average molecular weight (Mw) and number-average molecular weight (Mn), and to calculate the molecular weight distribution (Mw/Mn).

[Density]

The density of the copolymers obtained in Synthesis Examples below was calculated according to ASTM D 1505 (substitution in water method) from the mass of each copolymer measured in water and air using an electron hydrometer MD-300S manufactured by Alpha-Mirage Corporation.

[Melting Point (Tm)]

The melting point (Tm) of the copolymers obtained in Synthesis Examples below was measured by differential scanning calorimeter (DSC) using a DSC220C instrument manufactured by Seiko Instruments Inc.

Specifically, 7 to 12 mg of the copolymer obtained in the Synthesis Example below was sealed in an aluminum pan and heated from room temperature to 200° C. at a rate of 10° C./min.

The copolymers were then held at 200° C. for 5 min for complete melting and then cooled to −50° C. at 10° C./min. After 5 minutes at −50° C., the sample was reheated to 200° C. at 10° C./min. The peak temperature on this repeated (second) heating was taken as the melting point (Tm).

[Dynamic Viscoelasticity of Copolymer]

Sheets were obtained by heating the copolymers obtained in Synthesis Examples below for 5 minutes without applying any pressure and then for 1 to 2 minutes under 10 MPa of pressure using a hydraulic thermal press manufactured by SHINTO Metal Industries Corporation, set at 190° C. Next, samples for measurement (3 mm thick sheets) were prepared by applying a pressure of 10 MPa to the obtained sheets for about 5 minutes using another hydraulic thermal press manufactured by SHINTO Metal Industries Corporation, set at 20° C. A brass plate with a thickness of 5 mm was used as a hot plate when applying the pressure.

Using the obtained measurement samples and MCR 301 manufactured by ANTON Paar, the temperature dependence of the dynamic viscoelasticity was measured at a frequency of 10 rad/s (1.6 Hz) at −100 to 150° C. and the temperature at which the loss tangent (tan δ) due to the glass transition temperature reached its maximum (hereinafter also referred to as “peak temperature”) and the value of the loss tangent (tan δ) at that time (hereinafter also referred to as “peak value”) were measured in the range of 0 to 60° C.

[Dynamic Viscoelasticity of Resin Composition]

In the same manner as the dynamic viscoelasticity of the copolymers, except that the resin composition obtained in Examples and Comparative Examples below was used instead of the copolymers obtained in Synthesis Examples below, the temperature at which the loss tangent (tan δ) of the resin composition reached its maximum (hereinafter also referred to as “peak temperature”) and the value of the loss tangent (tan δ) at that time (hereinafter also referred to as “peak value”) were measured. The peak temperature and peak value at which the peak temperature is in the range of lower than 0° C. are referred to as the first peak temperature and the first peak value, respectively, and the peak temperature and peak value at which the peak temperature is in the range of 0° C. or higher are referred to as the second peak temperature and the second peak value, respectively.

[Adhesion Strength]

The adhesion strength of the multilayer body obtained in the following Examples and Comparative Examples was measured in accordance with JIS Z 0237:2000. Specifically, the adhesion strength was measured as follows.

A black acrylic plate (ACRYLITE REX, manufactured by Mitsubishi Chemical Corporation) 50 mm wide×100 mm long×2 mm thick and a multilayer body obtained in Examples and Comparative Examples below were left in an environment with a temperature of 23° C. and a relative humidity of 50% for 1 hour, then the multilayer body was placed on the acrylic plate so that the adhesive layer (L1) of the multilayer body obtained in Examples and Comparative Examples below was in contact with the acrylic plate, and a test specimen was prepared by using a rubber roll of about 2 kg, making the rubber roll reciprocate twice with applying pressure and sticking the multilayer body on the acrylic plate. After the prepared test specimens were placed in a constant environment at a temperature of 23° C. and a relative humidity of 50% for 1 day, the adhesion strength was measured using a universal tensile testing machine (3380, manufactured by Instron) when the multilayer body was peeled off from the acrylic plate at a speed of 300 mm/min in a 180° direction in an environment at a temperature of 23° C. and a relative humidity of 50% (adhesion strength at 23° C.).

The adhesive strength (adhesion strength after heating at 60° C.) was measured in the same manner as described above, except that the prepared test specimen was placed in an oven at 60° C. for 1 day instead of being placed in a constant environment at a temperature of 23° C. and a relative humidity of 50% for 1 day.

Further, the adhesive strength (adhesion strength after heating at 80° C.) was measured in the same manner as described above, except that the prepared test specimen was placed in an oven at 80° C. for 1 day instead of being placed in a constant environment at a temperature of 23° C. and a relative humidity of 50% for 1 day.

[Adhesion Increasing Rate]

Using the values of the adhesion strength at 23° C. and the adhesion strength after heating at 60° C. measured by the method described above, the adhesion increasing rate upon heating at 60° C. was calculated based on the following formula (2); and using the values of the adhesion strength at 23° C. and the adhesion strength after heating at 80° C., the adhesion increasing rate upon heating at 80° C. was calculated based on the following formula (3).

Adhesion increasing rate upon heating at 60° C.={(Adhesion strength after heating at 60° C.)−(Adhesion strength at 23° C.)}/(Adhesion strength at 23° C.)×100 (2)

Adhesion increasing rate upon heating at 80° C.={(Adhesion strength after heating at 80° C.)−(Adhesion strength at 23° C.)}/(Adhesion strength at 23° C.)×100 (3)

### Synthesis Example 1

Into a fully nitrogen-substituted SUS autoclave with stirring blades having a capacity of 1.5 liters, 750 ml of 4 methyl-1-pentene was charged at 23° C. The autoclave was charged with 0.75 ml of a 1.0 mmol/ml toluene solution of triisobutylaluminum (TIBAL) and the stirrer was turned.

The autoclave was then heated to an internal temperature of 60° C. and pressurized with propylene to a total pressure of 0.13 MPa (gauge pressure). Subsequently, 0.34 ml of a toluene solution containing 1 mmol of methylaluminoxane converted in terms of Al and 0.01 mmol of diphenylmethylene (1-ethyl-3-t-butyl-cyclopentadienyl) (2,7-di-t-butyl-fluorenyl) zirconium dichloride, which had been prepared in advance, was injected into an autoclave under pressure with nitrogen to initiate polymerization. The temperature was adjusted so that the internal temperature of the autoclave was 60° C. during the polymerization reaction. After 60 minutes from the initiation of the polymerization, 5 ml of methanol was injected into the autoclave under pressure with nitrogen to terminate the polymerization, and the autoclave was depressurized to atmospheric pressure. Thereafter, acetone was poured into the reaction solution while stirring.

The powdery polymer containing the obtained solvent was dried at 100° C. under reduced pressure for 12 hours. The amount of the obtained 4-methyl-1-pentene/α-olefin copolymer (A-1-1) was 36.9 g, and the content of the structural unit (i) in the polymer was 72.5 mol %, and the content of the structural unit (ii) was 27.5 mol %. Table 1 shows the physical properties of the obtained copolymer.

### Synthesis Example 2

Into a fully nitrogen-substituted SUS autoclave with stirring blades having a capacity of 1.5 liters, 300 ml of n-hexane (dried over activated alumina in dry nitrogen gas atmosphere) and 450 ml of 4 methyl-1-pentene were charged at 23° C. The autoclave was charged with 0.75 ml of a 1.0 mmol/ml toluene solution of triisobutylaluminum (TIBAL) and the stirrer was turned.

The autoclave was then heated to an internal temperature of 60° C. and pressurized with propylene to a total pressure of 0.19 MPa (gauge pressure). Subsequently, 0.34 ml of a toluene solution containing 1 mmol of methylaluminoxane converted in terms of Al and 0.01 mmol of diphenylmethylene (1-ethyl-3-t-butyl-cyclopentadienyl) (2,7-di-t-butyl-fluorenyl) zirconium dichloride, which had been prepared in advance, was injected into an autoclave under pressure with nitrogen to initiate polymerization. The temperature was adjusted so that the internal temperature of the autoclave was 60° C. during the polymerization reaction. After 60 minutes from the initiation of the polymerization, 5 ml of methanol was injected into the autoclave under pressure with nitrogen to terminate the polymerization, and the autoclave was depressurized to atmospheric pressure. Thereafter, acetone was poured into the reaction solution while stirring.

The powdery polymer containing the obtained solvent was dried at 100° C. under reduced pressure for 12 hours. The amount of the obtained 4-methyl-1-pentene/α-olefin copolymer (A-2-1) was 44.0 g, and the content of the structural unit (i) in the polymer was 84.1 mol %, and the content of the structural unit (ii) was 15.9 mol %. Table 1 shows the physical properties of the obtained copolymer.

TABLE 1

| | | | Copolymer | Copolymer |
|---|---|---|---|---|
| | | | (A-1-1) | (A-2-1) |
| Composition | Content of structural | mol % | 72.5 | 84.1 |
| | unit(i) | | | |
| | Structural unit (ii) type | — | Propylene | Propylene |
| | Content of structural | mol % | 27.5 | 15.9 |
| | unit(ii) | | | |

| | | | |
|---|---|---|---|
| Intrinsic viscosity [η] | dl/g | 1.5 | 1.5 |
| Weight-average molecular weight (Mw) | — | 337000 | 340000 |
| Molecular weight distribution (Mw/Mn) | — | 2.1 | 2.1 |
| Density | kg/m³ | 839 | 838 |
| Melting point (Tₘ) | ° C. | Not observed | 132 |
| tanδ: Peak temperature | ° C. | 30 | 43 |
| tanδ: Peak value | — | 2.78 | 1.46 |

### Example 1

A resin composition (resin pellet) for forming the adhesive layer (L1) was obtained by blending 15 parts by mass of 4-methyl-1-pentene/α-olefin copolymer (A-1-1), 5 parts by mass of 4-methyl-1-pentene/α-olefin copolymer (A-2-1), 80 parts by mass of TUFTEC H1052 (hereinafter also referred to as “B2-1”) manufactured by Asahi Kasei Corporation, and 0.2 parts by mass of n-octadecyl-3-(4′-hydroxy-3′,5′-di-t-butylphenyl)propionate as a heat-resistant stabilizer.

Using a three-type three-layer T-die molding machine with a die width of 300 mm equipped with a 30 mmφ single-axis extruder, a resin feed hopper connected to a T-die for forming each of the front surface layer (L3), the base material layer (L2), and the adhesive layer (L1) was used to feed resin pellets for forming each layer, the resin pellets were melted through a cylinder in the single-axis extruder set at 200 to 240° C., and then extrusion forming from the T-die was performed at a die temperature of 200° C. to obtain the multilayer body.

At this time, polypropylene F107 manufactured by Prime Polymer Co., Ltd. was used as the resin pellets for forming the front surface layer (L3) and the base material layer (L2), and the obtained resin composition was used as the resin pellets for forming the adhesive layer (L1). The surface layer (L3), the base material layer (L2), and the adhesive layer (L1) were extruded so that the thicknesses were L3/L2/L1=10/30/10 μm. Table 2 shows various physical properties of the obtained multilayer body.

### Example 2

A multilayer body was obtained by the same method as in Example 1, except that 10 parts by mass of 4-methyl-1-pentene/α-olefin copolymer (A-1-1), 10 parts by mass of 4-methyl-1-pentene/α-olefin copolymer (A-2-1), 80 parts by mass of TUFTEC H1052 (B2-1) manufactured by Asahi Kasei Corporation, and 0.2 parts by mass of n-octadecyl-3-(4′-hydroxy-3′,5′-di-t-butylphenyl)propionate were used as raw materials for the resin composition. Table 2 shows various physical properties thereof.

### Example 3

A multilayer body was obtained by the same method as in Example 1, except that 10 parts by mass of 4-methyl-1-pentene/α-olefin copolymer (A-1-1), 10 parts by mass of 4-methyl-1-pentene/α-olefin copolymer (A-2-1), 80 parts by mass of DYNARON 1320P (hereinafter, also referred to as “B2-2”) manufactured by JSR Corporation, and 0.2 parts by mass of n-octadecyl-3-(4′-hydroxy-3′,5′-di-t-butylphenyl)propionate were used as raw materials for the resin composition. Table 2 shows various physical properties thereof.

### Example 4

A multilayer body was obtained by the same method as in Example 1, except that 10 parts by mass of 4-methyl-1-pentene/α-olefin copolymer (A-1-1), 10 parts by mass of 4-methyl-1-pentene/α-olefin copolymer (A-2-1), 80 parts by mass of TAFMER PN-3560 (hereinafter, also referred to as “B1-1”) manufactured by Mitsui Chemicals, and 0.2 parts by mass of n-octadecyl-3-(4′-hydroxy-3′,5′-di-t-butylphenyl)propionate were used as raw materials for the resin composition. Table 2 shows various physical properties thereof.

### Example 5

A multilayer body was obtained by the same method as in Example 1, except that 10 parts by mass of 4-methyl-1-pentene/α-olefin copolymer (A-1-1), 10 parts by mass of 4-methyl-1-pentene/α-olefin copolymer (A-2-1), 80 parts by mass of TAFMER PN-2060 (hereinafter, also referred to as “B1-2”) manufactured by Mitsui Chemicals, and 0.2 parts by mass of n-octadecyl-3-(4′-hydroxy-3′,5′-di-t-butylphenyl)propionate were used as raw materials for the resin composition. Table 2 shows various physical properties thereof.

### Example 6

A multilayer body was obtained by the same method as in Example 1, except that 5 parts by mass of 4-methyl-1-pentene/α-olefin copolymer (A-1-1), 5 parts by mass of 4-methyl-1-pentene/α-olefin copolymer (A-2-1), 90 parts by mass of TUFTEC H1052 (B2-1) manufactured by Asahi Kasei Corporation, and 0.2 parts by mass of n-octadecyl-3-(4′-hydroxy-3′,5′-di-t-butylphenyl)propionate were used as raw materials for the resin composition. Table 2 shows various physical properties thereof.

### Example 7

A multilayer body was obtained by the same method as in Example 1, except that 5 parts by mass of 4-methyl-1-pentene/α-olefin copolymer (A-1-1), 3 parts by mass of 4-methyl-1-pentene/α-olefin copolymer (A-2-1), 92 parts by mass of TAFMER PN-2060 (B1-2) manufactured by Mitsui Chemicals, and 0.2 parts by mass of n-octadecyl-3-(4′-hydroxy-3′,5′-di-t-butylphenyl)propionate were used as raw materials for the resin composition. Table 2 shows various physical properties thereof.

### Example 8

A multilayer body was obtained by the same method as in Example 1, except that 20 parts by mass of 4-methyl-1-pentene/α-olefin copolymer (A-1-1), 20 parts by mass of 4-methyl-1-pentene/α-olefin copolymer (A-2-1), 60 parts by mass of TUFTEC H1052 (B2-1) manufactured by Asahi Kasei Corporation, and 0.2 parts by mass of n-octadecyl-3-(4′-hydroxy-3′,5′-di-t-butylphenyl)propionate were used as raw materials for the resin composition. Table 2 shows various physical properties thereof.

### Example 9

A multilayer body was obtained by the same method as in Example 1, except that 10 parts by mass of 4-methyl-1-pentene/α-olefin copolymer (A-1-1), 10 parts by mass of 4-methyl-1-pentene/α-olefin copolymer (A-2-1), 80 parts by mass of SIBSTAR 072T (hereinafter, also referred to as “B2-3”) manufactured by Kaneka Corporation, and 0.2 parts by mass of n-octadecyl-3-(4′-hydroxy-3′,5′-di-t-butylphenyl)propionate were used as raw materials for the resin composition. Table 2 shows various physical properties thereof.

### Example 10

A multilayer body was obtained by the same method as in Example 1, except that 5 parts by mass of 4-methyl-1-pentene/α-olefin copolymer (A-1-1), 15 parts by mass of 4-methyl-1-pentene/α-olefin copolymer (A-2-1), 80 parts by mass of TUFTEC H1052 (B2-1) manufactured by Asahi Kasei Corporation, and 0.2 parts by mass of n-octadecyl-3-(4′-hydroxy-3′,5′-di-t-butylphenyl)propionate were used as raw materials for the resin composition. Table 2 shows various physical properties thereof.

### Comparative Example 1

A multilayer body was obtained by the same method as in Example 1, except that 100 parts by mass of TUFTEC H1052 (B2-1) manufactured by Asahi Kasei Corporation and 0.2 parts by mass of n-octadecyl-3-(4′-hydroxy-3′,5′-di-t-butylphenyl)propionate were used as raw materials for the resin composition. Table 3 shows various physical properties thereof.

### Comparative Example 2

A multilayer body was obtained by the same method as in Example 1, except that 100 parts by mass of TAFMER PN-3560 (B1-1) manufactured by Mitsui Chemicals and 0.2 parts by mass of n-octadecyl-3-(4′-hydroxy-3′,5′-di-t-butylphenyl)propionate were used as raw materials for the resin composition. Table 3 shows various physical properties thereof.

### Comparative Example 3

A multilayer body was obtained by the same method as in Example 1, except that 20 parts by mass of TAFMER PN-2060 (B1-2) manufactured by Mitsui Chemicals, 80 parts by mass of TUFTEC H1052 (B2-1) manufactured by Asahi Kasei Corporation and 0.2 parts by mass of n-octadecyl-3-(4′-hydroxy-3′,5′-di-t-butylphenyl)propionate were used as raw materials for the resin composition. Table 3 shows various physical properties thereof.

### Comparative Example 4

A multilayer body was obtained by the same method as in Example 1, except that 10 parts by mass of 4-methyl-1-pentene/α-olefin copolymer (A-1-1), 10 parts by mass of TAFMER PN-2060 (B1-2) manufactured by Mitsui Chemicals, 80 parts by mass of TUFTEC H1052 (B2-1) manufactured by Asahi Kasei Corporation, and 0.2 parts by mass of n-octadecyl-3-(4′-hydroxy-3′,5′-di-t-butylphenyl)propionate were used as raw materials for the resin composition. Table 3 shows various physical properties thereof.

TABLE 2

| | | | Ex. 1 | Ex. 2 | Ex. 3 | Ex. 4 | Ex. 5 |
|---|---|---|---|---|---|---|---|
| Composition | 4-methyl-1- | type | A-1-1 | A-1-1 | A-1-1 | A-1-1 | A-1-1 |
| | pentene/α-olefin | % by | 15 | 10 | 10 | 10 | 10 |
| | copolymer (A) | mass | | | | | |
| | | type | A-2-1 | A-2-1 | A-2-1 | A-2-1 | A-2-1 |
| | | % by | 5 | 10 | 10 | 10 | 10 |
| | | mass | | | | | |
| | Olefin elastomer | type | — | — | — | B1-1 | B1-2 |
| | (B1) | % by | — | — | — | 80 | 80 |
| | | mass | | | | | |
| | Styrene elastomer | type | B2-1 | B2-1 | B2-2 | — | — |
| | (B2) | % by | 80 | 80 | 80 | — | — |
| | | mass | | | | | |
| Dynamic | First peak | ° C. | −42 | −42 | −29 | −16 | −19 |
| viscoelasticity | temperature | | | | | | |
| | First peak value | — | 1.51 | 1.34 | 1.43 | 0.81 | 0.60 |
| | Second peak | ° C. | 38.6 | 39.3 | 36.8 | 32.1 | 34.0 |
| | temperature | | | | | | |
| | Second peak | — | 0.33 | 0.28 | 0.29 | 0.23 | 0.24 |
| | value | | | | | | |
| Adhesion | Adhesion | N/50 | 11.0 | 13.0 | 12.4 | 2.3 | 1.1 |
| characteristics | strength at 23° C. | mm | | | | | |
| | Adhesion | | 16.7 | 15.7 | 22.0 | 4.5 | 1.8 |
| | strength after | | | | | | |
| | heating at 60° C. | | | | | | |
| | Adhesion | | 17.3 | 14.9 | 20.8 | 3.7 | 1.7 |
| | strength after | | | | | | |
| | heating at 80° C. | | | | | | |
| | Adhesion | % | 51 | 21 | 78 | 94 | 68 |
| | increase rate | | | | | | |
| | upon heating at | | | | | | |
| | 60° C. | | | | | | |
| | Adhesion | % | 57 | 14 | 68 | 58 | 60 |
| | increase rate | | | | | | |
| | upon heating at | | | | | | |
| | 80° C. | | | | | | |
| | | | Ex. 6 | Ex. 7 | Ex. 8 | Ex. 9 | Ex. 10 |
| Composition | 4-methyl-1- | type | A-1-1 | A-1-1 | A-1-1 | A-1-1 | A-1-1 |
| | pentene/α-olefin | % by | 5 | 5 | 20 | 10 | 5 |
| | copolymer (A) | mass | | | | | |
| | | type | A-2-1 | A-2-1 | A-2-1 | A-2-1 | A-2-1 |
| | | % by | 5 | 3 | 20 | 10 | 15 |
| | | mass | | | | | |
| | Olefin elastomer | type | — | B1-2 | — | — | — |
| | (B1) | % by | — | 92 | — | — | — |
| | | mass | | | | | |
| | Styrene | type | B2-1 | — | B2-1 | B2-3 | B2-1 |
| | elastomer (B2) | % by | 90 | — | 60 | 80 | 80 |
| | | mass | | | | | |
| Dynamic | First peak | ° C. | −42 | −19 | −39 | −33 | −42 |
| viscoelasticity | temperature | | | | | | |
| | First peak value | — | 1.62 | 0.73 | 1.12 | 1.2 | 1.54 |
| | Second peak | ° C. | 38.4 | 33.1 | 39.3 | 32.1 | 40.1 |
| | temperature | | | | | | |
| | Second peak | — | 0.20 | 0.15 | 0.56 | 0.23 | 0.21 |
| | value | | | | | | |
| Adhesion | Adhesion | N/50 | 14.8 | 0.8 | 8.5 | 19.8 | 10.2 |
| characteristics | strength at 23° C. | mm | | | | | |
| | Adhesion | | 17.2 | 1.3 | 11.4 | 23.4 | 15.4 |
| | strength after | | | | | | |
| | heating at 60° C. | | | | | | |
| | Adhesion | | 16.9 | 1.3 | 10.1 | 24.1 | 13.8 |
| | strength after | | | | | | |
| | heating at 80° C. | | | | | | |
| | Adhesion | % | 16 | 63 | 34 | 18 | 51 |
| | increase rate | | | | | | |
| | upon heating at | | | | | | |
| | 60° C. | | | | | | |
| | Adhesion | % | 14 | 63 | 19 | 22 | 35 |
| | increase rate | | | | | | |
| | upon heating at | | | | | | |
| | 80° C. | | | | | | |

TABLE 3

| | | | Comp. | Comp. | Comp. | Comp. |
|---|---|---|---|---|---|---|
| | | | Ex. 1 | Ex. 2 | Ex. 3 | Ex. 4 |
| Composition | 4-methyl-1- | type | — | — | — | A-1-1 |
| | pentene/α-olefin | % by | — | — | — | 10 |
| | copolymer (A) | mass | | | | |
| | | type | — | — | — | — |
| | | % by | — | — | — | — |
| | | mass | | | | |
| | Olefin | type | — | B1-1 | B1-2 | B1-2 |
| | elastomer (B1) | % by | — | 100 | 20 | 10 |
| | | mass | | | | |
| | Styrene | type | B2-1 | — | B2-1 | B2-1 |
| | elastomer(B2) | % by | 100 | — | 80 | 80 |
| | | mass | | | | |
| Dynamic | First peak | ° C. | −42 | −19 | −42.1/ | −42.1/ |
| viscoelasticity | temperature | | | | −18.9 | −18.1 |
| | First peak value | | 1.45 | 0.77 | 1.52/ | 1.42/ |
| | | | | | 0.12 | 0.1 |
| | Second peak | ° C. | — | — | — | 28.9 |
| | temperature | | | | | |
| | Second peak | | — | — | — | 0.11 |
| | value | | | | | |
| Adhesion | Adhesion | N/50 | 11.2 | 5.2 | 12.1 | 10.8 |
| characteristics | strength at 23° C. | mm | | | | |
| | Adhesion | | 19.5 | 12.9 | 21.1 | 23.1 |
| | strength after | | | | | |
| | heating at 60° C. | | | | | |
| | Adhesion | | 26.4 | 14.0 | 24.6 | 23.0 |
| | strength after | | | | | |
| | heating at 80° C. | | | | | |
| | Adhesion | % | 75 | 147 | 74 | 115 |
| | increase rate | | | | | |
| | upon heating at | | | | | |
| | 60° C. | | | | | |
| | Adhesion | % | 136 | 166 | 103 | 113 |
| | increase rate | | | | | |
| | upon heating at | | | | | |
| | 80° C. | | | | | |

1. A resin composition (X) comprising:
a 4-methyl-1-pentene/α-olefin copolymer (A-1) satisfying following requirements (a) and (b);
a 4-methyl-1-pentene/α-olefin copolymer (A-2) satisfying following requirements (c) and (d); and
a thermoplastic resin (B) other than the copolymer (A-1) and the copolymer (A-2),
wherein a total content of the copolymer (A-1) and the copolymer (A-2) is 2 to 50% by mass, and a content of the thermoplastic resin (B) is 50 to 98% by mass, based on 100% by mass of a total of the copolymer (A-1), the copolymer (A-2), and the thermoplastic resin (B):
(a) when a total of a structural unit (i) derived from 4-methyl-1-pentene and a structural unit (ii) derived from an α-olefin having 2 to 20 carbon atoms excluding 4-methyl-1-pentene is 100 mol %, a content of the structural unit (i) is 65 to 80 mol %, and a content of the structural unit (ii) is 20 to 35 mol %;
(b) a melting point observed by a differential scanning calorimeter is lower than 110° C. or not observed;
(c) when a total of the structural unit (i) derived from 4-methyl-1-pentene and the structural unit (ii) derived from an α-olefin having 2 to 20 carbon atoms excluding 4-methyl-1-pentene is 100 mol %, a content of the structural unit (i) is 80 to 90 mol %, and a content of the structural unit (ii) is 10 to 20 mol %; and
(d) a melting point observed by a differential scanning calorimeter is 110 to 160° C.

2. The resin composition (X) according to claim 1, wherein as a tan δ peak obtained by performing dynamic viscoelastic measurement at a frequency of 10 rad/s in a temperature range of −100 to 150° C., the resin composition (X) has a first peak with a peak temperature of lower than 0° C. and a second peak with a peak temperature of 0° C. or higher.

3. The resin composition (X) according to claim 1, wherein a content of the copolymer (A-1) is 1 to 99% by mass, and a content of the copolymer (A-2) is 99 to 1% by mass, based on 100% by mass of the total content of the copolymer (A-1) and the copolymer (A-2).

4. The resin composition (X) according to claim 1, wherein at least one of the copolymer (A-1) and the copolymer (A-2) comprises a structural unit derived from propylene.

5. The resin composition (X) according to claim 1, wherein the structural unit (ii) of at least one of the copolymer (A-1) and the copolymer (A-2) is a structural unit derived from propylene.

6. The resin composition (X) according to claim 1, wherein the thermoplastic resin (B) is an olefin elastomer (B1).

7. The resin composition (X) according to claim 1, wherein the thermoplastic resin (B) is a styrene elastomer (B2).

8. An adhesive comprising the resin composition (X) according to claim 1.

9. A multilayer body comprising:
an adhesive layer (L1) formed from the resin composition (X) according to claim 1; and
a base material layer (L2).

10. The multilayer body according to claim 9, wherein the base material layer (L2) is a polypropylene layer.

11. A surface protection film comprising:
an adhesive layer formed from the resin composition (X) according to claim 1.

12. A method for producing a surface protection film, comprising a step of forming the surface protection film according to claim 11 by a T-die film forming method.

13. A method of protecting a surface having surface irregularity height of 0.1 to 300 μm using the surface protection film according to claim 11.
